(19) United States
(12) Patent Application Publication
(10) Pub. No.: US 2026/0178667 A1
(43) Pub. Date: Jun. 25, 2026

(54) HYBRID MACHINE LEARNING/VECTOR SEARCH ENTITY MATCHING

(71) Applicant: INTUIT INC., Mountain View, CA (US)

(72) Inventors: Ido Meir MINTZ, Tel Aviv (IL); Yoni RABIN, Kfar Saba (IL); Guy SHTAR, Ness Ziona (IL); Natalie BAR ELIYAHU, Azor (IL)

(21) Appl. No.: 18/987,248

(22) Filed: Dec. 19, 2024

(51) Int. Cl. G06F 16/903

(52) U.S. Cl. CPC G06F 16/903

(57) ABSTRACT

Aspects of the present disclosure relate to automated entity matching. Embodiments include creating an embedding representation of a target entity. Embodiments further include retrieving, based on a semantic similarity comparison involving the embedding representation of the target entity and embedding representations of a set of entities, a subset of entities. Embodiments further include providing an input based on the target entity and the subset of entities to a large language model (LLM) that is configured to generate an output indicating a particular entity that matches the target entity. Embodiments further include receiving, from the LLM based on the input, an output indicating a given entity that matches the target entity.

### INTRODUCTION

Aspects of the present disclosure relate to techniques for automatically matching entities within datasets. In particular, techniques described herein involve using an embedding vector search to select candidate matches for an entity. Then, the candidate matches and the entity may be provided to a machine learning model that is configured to identify a correct match from among the candidate matches.

### BACKGROUND

Every year, millions of people, businesses, and organizations around the world use databases that contain entities. For example, an organization may use databases to store entities such as data associated with user profiles. As another example, users may store entities such as documents in a database.

Managing such databases may involve matching newly received entities with existing entities within the database. For instance, an organization may receive new data associated with users (e.g., the data may comprise contact information or the like). To add the data to an existing user profile, the profile that corresponds to the data should first be identified. As another example, if a received document is a duplicate of an existing document within a database, the existing document should be identified to prevent the uploading of a duplicate document (or to update the existing document based on changes in the duplicate version).

However, entity matching can be a highly complicated and costly process. For example, databases (e.g., user profile databases) can contain millions of entities (e.g., user profiles). Accurately matching newly received entities to existing entities within such large databases can require an exorbitant amount of computing resources and/or manual labor. Entirely manual matching for large databases may be impractical. Existing techniques for automating the matching process may rely on using a machine learning model such as a large language model (LLM) to compare a received entity to each entity in a database to identify a match. However, these existing automated techniques can lead to extreme latency and cost (e.g., computational and/or financial cost). For example, using an LLM to compare ten thousand newly received contacts to each user profile within a database that contains five million user profiles can cost more than ten million dollars and require several weeks of processing. In addition to the exorbitant cost, existing automated matching techniques may also be prone to errors (e.g., false positive matches and false negative matches).

Thus, there is a need in the art for improved techniques of automatically matching entities within datasets.

### BRIEF SUMMARY

Certain embodiments provide a method of automated entity matching. The method generally includes: creating an embedding representation of a target entity; retrieving, based on a semantic similarity comparison involving the embedding representation of the target entity and embedding representations of a set of entities, a subset of entities; providing an input based on the target entity and the subset of entities to a large language model (LLM) that is configured to generate an output indicating a particular entity that matches the target entity; and receiving, from the LLM based on the input, an output indicating a given entity that matches the target entity.

Certain embodiments provide a method of automated entity matching. The method generally includes: creating an embedding representation of a target entity; providing the embedding representation of the target entity as input to an optimization machine learning model, wherein the optimization machine learning model is trained to generate an output indicating a number of candidate entities for target entities; retrieving, based on a semantic similarity comparison involving the embedding representation of the target entity and embedding representations of a set of entities, a subset of entities comprising a number of entities indicated by an output of the optimization machine learning model; providing an input based on the target entity and the subset of entities to a large language model (LLM) that is configured to generate confidence scores that indicate a likelihood that a particular entity is a match with the target entity; receiving a confidence score associated with a given entity of the subset of entities from the LLM in response to the input; and selecting the given entity as a match for the target entity based on the confidence score exceeding a threshold.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated entity matching.

FIG. 2 depicts an additional example of computing components related to automated entity matching.

FIG. 3 depicts an additional example of computing components related to automated entity matching.

FIG. 4 depicts example operations related to automated entity matching.

FIG. 5 depicts additional example operations related to automated entity matching.

FIG. 6 depicts an example of a processing system for automated entity matching.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated entity matching.

To match a target entity into a large dataset (e.g., a dataset containing millions of entities), certain techniques described herein involve narrowing the dataset using an embedding vector search. For example, embedding representations of the entities within the dataset may be created and compared to an embedding representation of the target entity using a semantic similarity algorithm—the entities in the dataset that are most semantically similar to the target entity may be included in the narrowed dataset. Then, a large language model (LLM) may be used to compare the narrowed dataset to the target entity to identify a correct match for the target entity. Certain actions may be taken once such a match has been identified, such as merging the correct match and the target entity, updating the correct match based on the target entity, blocking a duplicate entity from being uploaded to a database, and/or the like.

As a further improvement, in some cases an optimization machine learning model may be used to determine an optimal number of candidates to retrieve (e.g., a number of entities to include in the narrowed dataset). The optimization machine learning model may be a machine learning model that is trained based on historical associations between the number of candidate matches used in an entity matching process and the success of the entity matching process. For example, the optimization machine learning model may generate a prediction indicating a number of candidate matches based on the entity to be matched and/or the entities in the database. The predicted number of candidates may then be retrieved (e.g., using semantic matching techniques, as described above), and a correct match may be identified from among the candidates.

Embodiments of the present disclosure provide numerous technical and practical effects and benefits. By using a hybrid matching approach that combines embedding vector searches with the computational power of LLMs, techniques disclosed herein lead to improved accuracy while drastically reducing the computational cost of matching processes. For example, performing embedding vector searches involving an extremely large dataset to first narrow the dataset before using an LLM to analyze the narrowed dataset may require significantly less time and computational resources than comparing each item in the entire dataset using a LLM. Thus, using an embedding vector search to narrow the pool of candidates may improve the efficiency of entity matching systems by ensuring that only relevant entities (e.g., entities that are likely to be matches) are compared using an LLM.

Furthermore, embodiments of the present disclosure improve the accuracy of entity matching systems. For example, by reducing the candidate pool using an embedding vector search, the amount of false positive matches may also be reduced. Narrowing the candidate pool to exclude entities that are not semantically similar to the target entity eliminates the possibility of an LLM erroneously determining that the dissimilar entities are matches. In other words, the embedding vector search provides an extra layer of protection against false positive matches. Experimental results indicate that embodiments of the present disclosure produce up to five hundred times fewer false positive matches than techniques that do not utilize embedding vector searches to narrow the pool of candidate matches.

Additionally, certain aspects of the present disclosure further improve the accuracy and resource-efficiency of automated entity matching techniques by using an optimization machine learning model to predict an optimal number of candidate matches to retrieve through a semantic match process and provide as candidates to a language processing machine learning model, thereby providing additional technical improvements over alternative automated entity matching techniques.

### Example of Computing Components Related to Automated Entity Matching

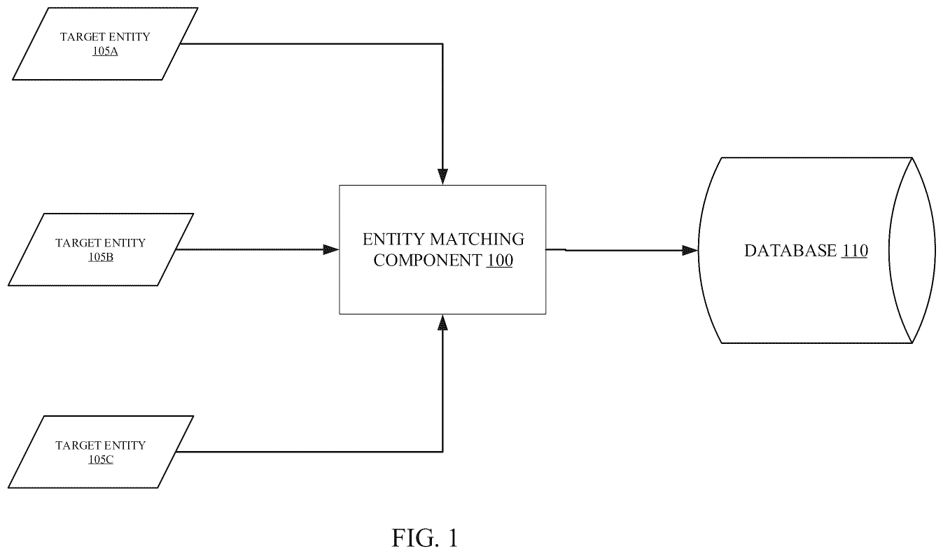

FIG. 1 depicts an example of computing components related to automated entity matching.

Target entities 105A-C may be collected by and/or provided to an entity matching component 100. Entities may generally be any type of data. For example, target entities 105A-C may comprise data associated with a user of a software application or service (e.g., contact information, user profile data, and/or the like). As another example, target entities 105A-C may be documents submitted by users.

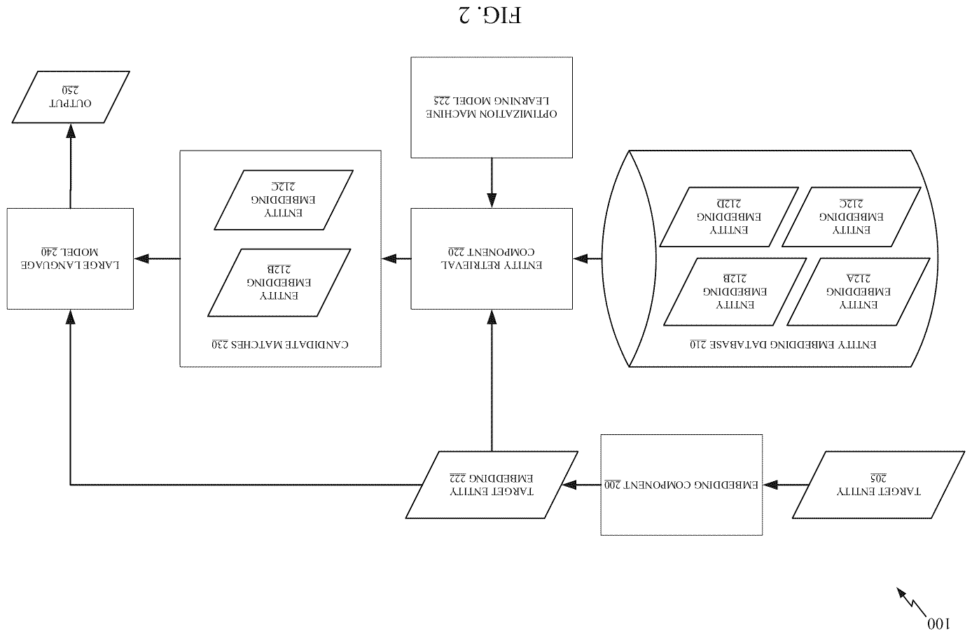

As described in further detail below with respect to FIG. 2, entity matching component 100 may comprise one or more computing components that are configured to match target entities 105A-C with entities found in database 110.

As an example, the database 110 may be a database used to store user profile data associated with users of an application or service. The database 110 may include millions of user profiles. The target entities 105A-C may each comprise data associated with existing users and/or prospective new users. For example, the target entities 105A-C may comprise contact information for existing users, data associated with the users that is collected from different applications, and/or the like. The entity matching component 100 may be used to identify a user profile to which a target entity 105 corresponds. For instance, database 110 may contain profile data associated with a given user's profile. Target entity 105B may include the given user's contact information. Entity matching component 100 may match the given user's profile with the target entity 105B. Based on the matching, the target entity 105B may be added to the given user's profile. If no matches are found, a new profile may be created based on the target entity 105B.

As another example, database 110 may be a repository, such as a repository for storing documents. The target entities 105A-C may each comprise different documents. The entity matching component 100 may be used to identify a document within the database 110 to which a target entity 105 corresponds. For instance, database 110 may contain a given document. Target entity 105A may be a duplicate copy of the given document or a revised version of the given document. The entity matching component 100 may be used to determine that target entity 105A is a copy or an updated version of the given document. Based on this determination, one or more actions may be taken, such as blocking the target entity 105A from being uploaded to the database, replacing the given document with the target entity 105A, appending the target entity 105A to the given document, modifying the given document based on the target entity 105A, and/or the like.

FIG. 2 depicts an additional example of computing components related to automated entity matching. In particular, FIG. 2 depicts entity matching component 100 of FIG. 1.

A target entity 205 may be provided to an embedding component 200. The embedding component 200 may be used to create embedding representations of entities such as the target entity 205. An embedding generally refers to a vector representation of an entity that represents the entity as a vector in n-dimensional space such that similar entities are represented by vectors that are close to one another in the n-dimensional space. The embedding component 200 may comprise an embedding model in some embodiments. The embedding model may comprise a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Jena AI, Word2Vec, and GloVe embeddings. These are included as examples, and other techniques for generating vector representations of entities (such as embedding representations) are possible.

Embeddings of entities within the database 110 may be created and stored within an entity embedding database 210. An entity retrieval component 220 may retrieve one or more of the entity embeddings 212A-D based on the target entity embedding 222. The entity retrieval component 220 may comprise a computing component that is configured to perform a semantic similarity comparison involving embeddings. This comparison may be performed by calculating the dot product between two embedding vectors, determining the cosine similarity, Jaccard similarity, Euclidean distance, or Levenshtein distance between two embedding vectors, or using other types of semantic similarity algorithms. The entity retrieval component 220 may use one of these semantic similarity algorithms to compare the target entity embedding 222 to the entity embeddings 212A-D. The entity embeddings 212 with the highest level of semantic similarity to the target entity 205 may be identified and retrieved as candidate matches 230 for the target entity 205.

In some embodiments, the number of retrieved entity embeddings 212 is based on an output from an optimization machine learning model 225. The optimization machine learning model 225 may be a machine learning model that is trained based on historical associations between the number of retrieved candidates and performance of an entity matching system. For example, the optimization machine learning model 225 may be provided with an input based on the target entity 205 and/or the entities within the entity embedding database 210. In response to the input, the optimization machine learning model 225 may generate an output indicating the number of entities that should be retrieved to achieve optimal performance from the matching system. The entity retrieval component 220 may retrieve the number of entities indicated by the output of the optimization machine learning model 225. For example, if the output of the optimization machine learning model 225 indicates that ten thousand entities should be retrieved, the ten thousand entities with the highest level of semantic similarity relative to the target entity 205 may be retrieved.

The optimization machine learning model 225 may be trained based on supervised, unsupervised or semi-supervised learning techniques. Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model, such as based on validation data and test data, as is known in the art. It is noted that “training” as used herein may refer to initial training, re-training, and/or fine tuning of a machine learning model, such as optimization machine learning model 225, large language model 240, and/or other machine learning models described herein.

A supervised learning process for the optimization machine learning model 225 may comprise providing a training input to the optimization machine learning model 225. The training input may comprise a target entity that was matched using an entity matching system and/or one or more of the entities from the database to which the target entity was matched. The training input may be associated with a label indicating a number of retrieved candidate entities that resulted in a correct match being found (e.g. a number of retrieved candidates may only be used as a label in some embodiments if it resulted in a correct match without using an excessive amount of computing resources). For example, too many candidates may result in excessive computing resource use, while too few candidates may result in the correct match being omitted from the candidates. The training input may be provided to the optimization machine learning model 225, and parameters of the optimization machine learning model 225 may be iteratively adjusted based on a variance between the label associated with the training input and the output generated by the optimization machine learning model 225.

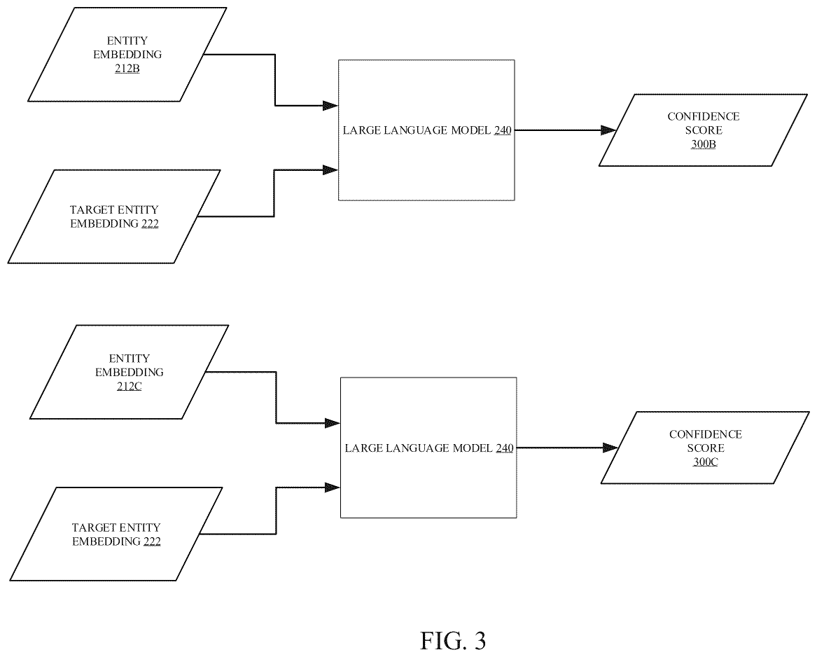

An input that is based on the retrieved candidate matches 230 and the target entity 205 may be provided to large language model 240. Large language model 240 may be trained and/or otherwise configured to generate an output 250 that indicates which entity of the retrieved candidate matches 230 is a correct match for the target entity 205. For example, as described in further detail below with respect to FIG. 3, large language model 240 may be provided with the target entity embedding 222 and an embedding of a candidate match. Large language model 240 may then generate an output 250, such as a confidence score that indicates a likelihood that the candidate match is a correct match for the target entity 205.

Certain embodiments provide that large language model 240 may be trained based on supervised, unsupervised or semi-supervised learning techniques. For example, large language model 240 may be trained through a supervised learning process involving training data that comprises historically matched target entities and historical candidate matches. The training data may be associated with a label that indicates which historical candidate match is a correct match for the historical target match. Parameters of the large language model 240 may be iteratively adjusted based on a variance between an output generated by the large language model 240 and the label.

In some embodiments, large language model 240 may be provided with few-shot examples. Few-shot learning involves providing a language model with a sequence of examples related to a task. In few-shot learning, the language model may learn from these examples and thus perform the task. Each few-shot example provided to large language model 240 may comprise a historical target entity, a historical set of candidate matches for the historical target entity, an indication of a correct match for the historical target entity, and/or embedding representations of entities such as the historical target entity and historical candidate matches. The few-shot examples may be provided as part of an input prompt to the large language model 240 along with the target entity 205 and the candidate matches 205. The large language model 240 may learn from the few-shot examples, and thus generate an output 250 that is more accurate. It is noted that functionality described herein with respect to large language model 240 may also be performed using one or more other types of language processing machine learning models.

In certain embodiments, a processing module (not shown) may be used to verify the output 250. For example, the output 250 may indicate that a particular candidate match is a correct match for the target entity 205. The processing module may be provided with an input based on the particular candidate and the target entity 205 and generate an output that indicates whether the particular candidate is a correct match for the target entity 205. Thus the processing module may serve as an additional layer of protection against false positive matches.

The processing module may comprise one or more computing components that are configured to confirm that an identified match is a correct match for a target entity 205. Certain embodiments provide that the processing module applies a set of rules to determine that the identified match is a correct match. For example, a rule may specify that the identified match must share at least a certain number of characters in common with the target entity 205, or must share one or more other features in common with the target entity 205.

In certain embodiments, the processing module comprises a machine learning model that is trained to determine whether an identified match is a correct match for the target entity 205. For example, the processing machine learning model may be trained through a supervised learning processing involving training data that comprises historical target entities, historical identified matches, and labels that indicate whether a historical identified match is a correct match for the historical target entity. In the supervised learning process, parameters of the processing machine learning model may be iteratively adjusted based on variances between the label and the output of the processing machine learning model.

The target entity 205 and an identified match for the target entity 205 may then be provided to the processing machine learning model, and the processing machine learning model may generate an output indicating whether the identified match is a correct match.

If the processing module determines that the identified match is not a correct match, one or more actions may be taken. For example, one or more steps of the matching process may be repeated. As an example, new embedding representations of entities may be created, new entities may be retrieved (e.g., more entities may be retrieved than in a previous matching attempt), the entities may be compared again using large language model 240, and/or the like. One or more machine learning models may be retrained, such as large language model 240, optimization machine learning model 225, a machine learning model used to create the embeddings, and/or the like. In some instances, if the processing module indicates that the identified match is not a correct match, it may be determined that no entities in the database match the target entity 205. One or more of the actions described above may be performed based on feedback received from users as well. For example, user feedback may indicate that an identified match is not a correct match, and one or more machine learning models may be retrained as a result.

FIG. 3 depicts an additional example of computing components related to automated entity matching. In particular, FIG. 3 depicts functionality associated with large language model 240 of FIG. 2.

As shown in FIG. 3, large language model 240 may be used to compare retrieved candidate embeddings, such as entity ambeddings 212B and 212C, to the target entity embedding 222. In some embodiments, large language model 240 may compare the candidate embeddings in order based on the semantic similarity of the candidate embeddings relative to the target entity embedding 222. For example, the entity retrieval component 220 may perform a semantic similarity comparison and determine that the level of semantic similarity for entity embedding 212B relative to the target entity embedding 222 is higher than the level of semantic similarity for entity embedding 212C relative to the target entity embedding 222. Based on this (e.g., the order of semantic similarity may be indicated by the ordering in which the candidate entity embeddings such as entity embeddings 212B and 212C are provided to large language model 240 and/or by rankings that are provided to large language model 240 for each candidate entity embedding such as entity embeddings 212B and 212C), large language 240 may compare entity embedding 212B to target entity embedding 222 before comparing entity embedding 212C to target entity embedding 222.

When provided with an input based on embedding 212B and target entity embedding 222, large language model 240 may generate a confidence score 300B. Confidence score 300B may indicate that likelihood that the entity corresponding to entity embedding 212B is a correct match for the target entity 205. If the confidence score exceeds a threshold, it may be determined that the entity is a correct match for target entity 205, and one or more actions may be performed (e.g., merging the identified match with target entity 205). Once the correct match is identified, the comparison of entities may be stopped. By comparing entities in order based on likelihood of the entities being a match (e.g., because entities that are more semantically similar may be more likely to be matches than other entities) and stopping the comparisons once a correct match is identified, techniques disclosed herein may conserve a significant amount of processing resources.

If confidence score 300B fails to meet the threshold, entity embedding 212C may be compared to target entity embedding 222 to generate confidence score 300C. If confidence score 300C fails to meet the threshold, an embedding corresponding to another retrieved candidate match (e.g., having a next highest semantic similarity to target entity embedding 222) may be compared to target entity embedding 222, and so on until a correct match has been identified or until all candidates have been compared to the target entity 205 without finding a correct match.

### Example Operations Related to Automated Entity Matching

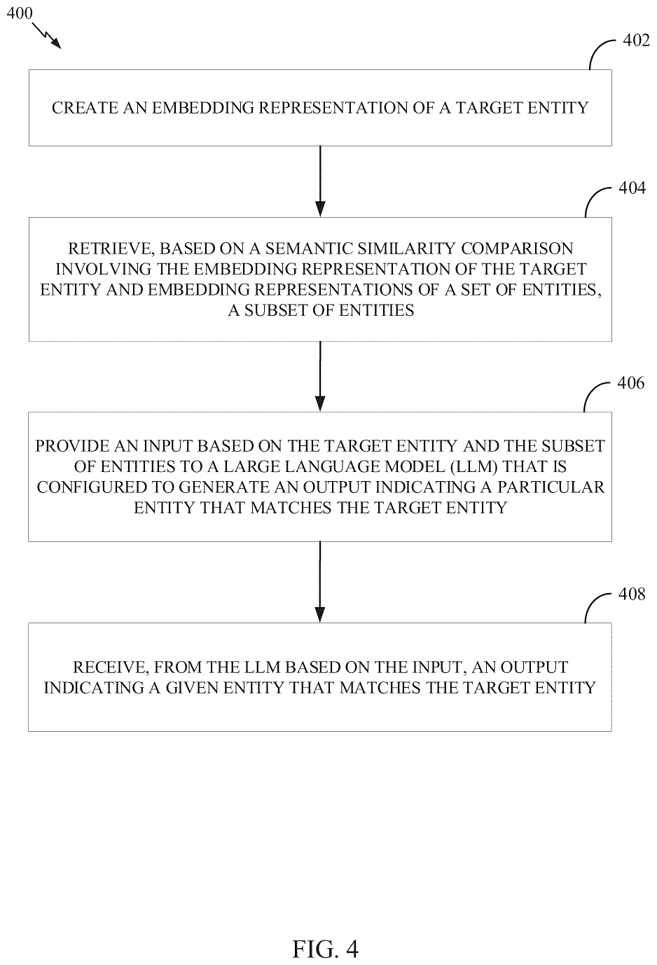

FIG. 4 depicts example operations 400 related to automated entity matching. For example, operations 400 may be performed by one or more of the components described with respect to FIG. 1, FIG. 2, and FIG. 3.

Operations 400 begin at step 402 with creating an embedding representation of a target entity.

Operations 400 continue at step 404 with retrieving, based on a semantic similarity comparison involving the embedding representation of the target entity and embedding representations of a set of entities, a subset of entities. In certain embodiments, an optimization machine learning model is used to predict a given number of entities to retrieve based on the target entity, wherein the given number of entities are included in the subset of entities. Some embodiments provide that an optimization machine learning model is used to predict a given number of entities to retrieve based on the set of entities, wherein the given number of entities are included in the subset of entities.

Operations 400 continue at step 406 with providing an input based on the target entity and the subset of entities to a large language model (LLM) that is configured to generate an output indicating a particular entity that matches the target entity. In certain embodiments, the input further includes few-shot examples comprising: a historical target entity; a historical subset of entities, and an indication of an entity of the historical subset of entities that matches the historical target entity.

Operations 400 continue at step 408 with receiving, from the LLM based on the input, an output indicating a given entity that matches the target entity. According to some embodiments, the output comprises a confidence score that indicates a likelihood that the given entity and the target entity match. Certain embodiments provide that confidence scores are generated with respect to the target entity and each respective entity of the subset of entities until a confidence score associated with a respective entity exceeds a threshold. In some embodiments, the confidence scores are generated in order based on a level of semantic similarity between the target entity and the respective entities. Certain embodiments provide that the target entity and the given entity are merged.

According to some embodiments, the output from the LLM is provided as an input to a processing machine learning model, wherein the processing machine learning model is trained to generate an additional output that indicates whether the given entity is a match for the target entity

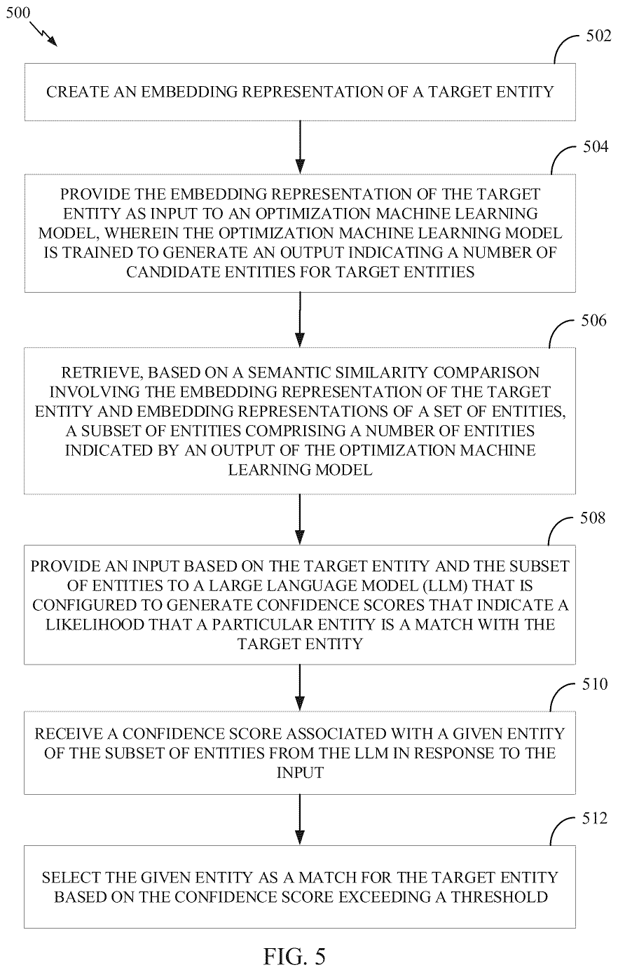

FIG. 5 depicts example operations 500 related to automated entity matching. For example, operations 500 may be performed by one or more of the components described with respect to FIG. 1, FIG. 2, and FIG. 3.

Operations 500 begin at step 502 with creating an embedding representation of a target entity.

Operations 500 continue at step 504 with providing the embedding representation of the target entity as input to an optimization machine learning model, wherein the optimization machine learning model is trained to generate an output indicating a number of candidate entities for target entities.

Operations 500 continue at step 506 with retrieving, based on a semantic similarity comparison involving the embedding representation of the target entity and embedding representations of a set of entities, a subset of entities comprising a number of entities indicated by an output of the optimization machine learning model.

Operations 500 continue at step 508 with providing an input based on the target entity and the subset of entities to a large language model (LLM) that is configured to generate confidence scores that indicate a likelihood that a particular entity is a match with the target entity. In certain embodiments, the input to the LLM further includes few-shot examples comprising: a historical target entity; a historical subset of entities, and an indication of an entity of the historical subset of entities that matches the historical target entity.

Operations 500 continue at step 510 with receiving a confidence score associated with a given entity of the subset of entities from the LLM in response to the input.

Operations 500 continue at step 512 with selecting the given entity as a match for the target entity based on the confidence score exceeding a threshold.

### Example of a Processing System for Automated Entity Matching

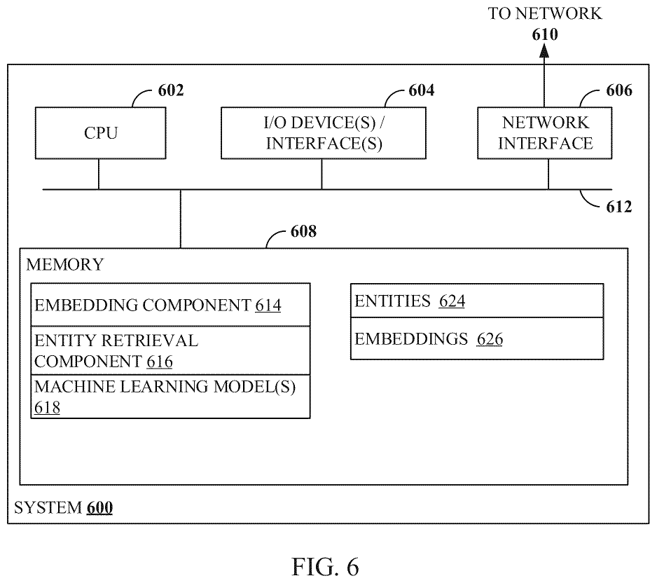

FIG. 6 illustrates an example system 600 with which embodiments of the present disclosure may be implemented. For example, system 600 may be configured to perform operations 400 of FIG. 4 or operations 500 of FIG. 5 and/or to implement one or more components as in FIG. 1, FIG. 2, or FIG. 3.

System 600 includes a central processing unit (CPU) 602, one or more I/O device interfaces that may allow for the connection of various I/O devices 604 (e.g., keyboards, displays, mouse devices, pen input, etc.) to the system 600, network interface 606, a memory 608, and an interconnect 612. It is contemplated that one or more components of system 600 may be located remotely and accessed via a network 610. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes embedding component 614, entity retrieval component 616, and machine learning model(s) 618. Embedding component 614 may be representative of embedding component 200 of FIG. 2. In some embodiments, entity retrieval component 616 may be representative of entity retrieval component 220 of FIG. 2. Machine learning model(s) 618 may be representative of optimization machine learning model 225 of FIG. 2 or large language model 240 of FIG. 2 and FIG. 3.

Memory 608 further comprises entities 624, which may correspond to target entities 105A-C of FIG. 1, target entity 205 of FIG. 2 or entities stored within database 110 of FIG. 1. Memory 608 further comprises embeddings 626 which may correspond to target entity embedding 222 of FIG. 2 and FIG. 3 or entity embeddings 212A-D of FIG. 2.

It is noted that in some embodiments, system 600 may interact with one or more external components, such as via network 610, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automated entity matching, comprising:
creating an embedding representation of a target entity;
retrieving, based on a semantic similarity comparison involving the embedding representation of the target entity and embedding representations of a set of entities, a subset of entities;
providing an input based on the target entity and the subset of entities to a large language model (LLM) that is configured to generate an output indicating a particular entity that matches the target entity; and
receiving, from the LLM based on the input, an output indicating a given entity that matches the target entity.

2. The method of claim 1, wherein the output comprises a confidence score that indicates a likelihood that the given entity and the target entity match.

3. The method of claim 2, further comprising generating confidence scores with respect to the target entity and each respective entity of the subset of entities until a confidence score associated with a respective entity exceeds a threshold.

4. The method of claim 3, wherein the confidence scores are generated in order based on a level of semantic similarity between the target entity and the respective entities.

5. The method of claim 1, wherein an optimization machine learning model is used to predict a given number of entities to retrieve based on the target entity, wherein the given number of entities are included in the subset of entities.

6. The method of claim 1, wherein an optimization machine learning model is used to predict a given number of entities to retrieve based on the set of entities, wherein the given number of entities are included in the subset of entities.

7. The method of claim 1, further comprising providing the output from the LLM as an input to a processing machine learning model, wherein the processing machine learning model is trained to generate an additional output that indicates whether the given entity is a match for the target entity.

8. The method of claim 1, wherein the input further includes few-shot examples comprising:
a historical target entity;
a historical subset of entities, and
an indication of an entity of the historical subset of entities that matches the historical target entity.

9. The method of claim 1, further comprising merging the target entity and the given entity.

10. A method of automated entity matching, comprising:
creating an embedding representation of a target entity;
providing the embedding representation of the target entity as input to an optimization machine learning model, wherein the optimization machine learning model is trained to generate an output indicating a number of candidate entities for target entities;
retrieving, based on a semantic similarity comparison involving the embedding representation of the target entity and embedding representations of a set of entities, a subset of entities comprising a number of entities indicated by an output of the optimization machine learning model;
providing an input based on the target entity and the subset of entities to a large language model (LLM) that is configured to generate confidence scores that indicate a likelihood that a particular entity is a match with the target entity;
receiving a confidence score associated with a given entity of the subset of entities from the LLM in response to the input; and
selecting the given entity as a match for the target entity based on the confidence score exceeding a threshold.

11. The method of claim 10, wherein the input provided to the LLM further includes few-shot examples comprising:
a historical target entity;
a historical subset of entities, and
an indication of an entity of the historical subset of entities that matches the historical target entity.

12. A system for automated entity matching, comprising:
one or more processors; and
a memory comprising instructions that, when executed by the one or more processors, cause the system to:
create an embedding representation of a target entity;
retrieve, based on a semantic similarity comparison involving the embedding representation of the target entity and embedding representations of a set of entities, a subset of entities;
provide an input based on the target entity and the subset of entities to a large language model (LLM) that is configured to generate an output indicating a particular entity that matches the target entity; and
receive, from the LLM based on the input, an output indicating a given entity that matches the target entity.

13. The system of claim 12, wherein the output comprises a confidence score that indicates a likelihood that the given entity and the target entity match.

14. The system of claim 13, wherein the instructions further cause the system to generate confidence scores with respect to the target entity and each respective entity of the subset of entities until a confidence score associated with a respective entity exceeds a threshold.

15. The system of claim 14, wherein the confidence scores are generated in order based on a level of semantic similarity between the target entity and the respective entities.

16. The system of claim 12, wherein an optimization machine learning model is used to predict a given number of entities to retrieve based on the target entity, wherein the given number of entities are included in the subset of entities.

17. The system of claim 12, wherein an optimization machine learning model is used to predict a given number of entities to retrieve based on the set of entities, wherein the given number of entities are included in the subset of entities.

18. The system of claim 12, wherein the instructions further cause the system to provide the output from the LLM as an input to a processing machine learning model, wherein the processing machine learning model is trained to generate an additional output that indicates whether the given entity is a match for the target entity.

19. The system of claim 12, wherein the input further includes few-shot examples comprising:
a historical target entity;
a historical subset of entities, and
an indication of an entity of the historical subset of entities that matches the historical target entity.

20. The system of claim 12, wherein the instructions further cause the system to merge the target entity and the given entity.
